(19) United States
(12) Patent Application Publication
(10) Pub. No.: US 2008/0124579 A1
(43) Pub. Date: May 29, 2008

(54) Magnetic recording medium, manufacturing method of the same and magnetic recording device

(75) Inventors: Isatake Kaitsu, Kawasaki (JP); Ryosaku Inamura, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/983,466

(22) Filed: Nov. 9, 2007

(30) Foreign Application Priority Data
Nov. 29, 2006 (JP) 2006-321932

(51) Int. Cl. G11B 5/33; B05D 5/12

(52) U.S. Cl. 428/800; 427/131

(57) ABSTRACT

A magnetic recording medium has high corrosion resistance and high Bs, a method of manufacturing the magnetic recording medium, and a magnetic recording device. The magnetic recording medium using as a recording layer a magnetic layer has perpendicular magnetic anisotropy. A soft magnetic backing layer (upper and lower soft magnetic backing layers) formed under the recording layer is composed of a FeCoZr alloy added with at least one element of Ta and Nb and further added with Cr. This magnetic recording medium includes the soft magnetic backing layer having high corrosion resistance and high Bs and therefore, exhibits high Hc recording and high S/N performance.

### CROSS-REFERENCE TO RELATED APPLICATIONS

This application is based upon and claims the benefits of priority from the prior Japanese Patent Application No. 2006-321932, filed on Nov. 29, 2006, the entire contents of which are incorporated herein by reference.

### BACKGROUND OF THE INVENTION

1. Field of the Invention

The present invention relates to a magnetic recording medium, a method of manufacturing the same, and a magnetic recording device. More particularly, the present invention relates to a magnetic recording medium utilizing perpendicular magnetic recording, a method of manufacturing the same, and a magnetic recording device.

2. Description of the Related Art

In recent years, an amount of information processed by a computer is increasing at a significant rate, and a recording device used with the computer is required to attain higher recording density.

Among many recording media, magnetic recording media such as magnetic disks in particular are historically older than the other media and generally used widely.

Most of magnetic recording media supplied to the market to date are in-plane magnetic recording media in which a direction of magnetization recorded in a recording layer is directed to the in-plane direction. To obtain higher recording density in the in-plane magnetic recording media, for example, a thickness of the recording layer is reduced, and a size of magnetic crystal grains constituting the recording layer is reduced for reduction in interaction between the magnetic crystal grains.

However, the magnetic crystal grains thus reduced in size cause decrease in their thermal stability and cause a phenomenon that information is lost by heat applied to the magnetic disk. Such a phenomenon is called thermal fluctuation and contributes to preventing higher recording density.

Therefore, for a magnetic recording medium which achieves higher recording density without reducing the size of magnetic crystal grains, a perpendicular magnetic recording medium has come into practical use in recent years. The perpendicular magnetic recording medium is a medium in which the direction of magnetization in the recording layer is directed to a perpendicular direction to the in-plane direction of the recording layer.

According to the perpendicular magnetic recording medium, compared with the in-plane magnetic recording medium, each magnetic domain requires a smaller area in the surface of the recording layer and therefore, higher recording density can be achieved. Furthermore, the magnetization is directed to the perpendicular direction to the in-plane direction of the recording layer and accordingly, the recording layer can be made thicker. Therefore, the thermal fluctuation which is caused in a thin recording layer is less likely to occur.

As a recording layer of the perpendicular magnetic recording medium, a granular recording layer is attracting attention recently. The granular recording layer includes columnar magnetic crystal grains long in the perpendicular direction of the recording layer, and the columnar magnetic crystal grains are separated from each other by an oxide or a nitride. For example, a CoPt (platinum) alloy is used for the magnetic crystal grains.

In such a perpendicular magnetic recording medium, an Hc (coercive force) of the recording layer must be elevated to obtain a record reproduction signal with higher recording density and higher quality. The perpendicular magnetic recording medium has a soft magnetic backing layer under the recording layer to generate high data writing magnetization. The easiness of writing is different depending on materials and magnetic characteristics of the soft magnetic backing layer.

This soft magnetic backing layer plays a part in the write head function. As the product of Bs (saturation flux density) and thickness of the soft magnetic backing layer is larger, the number of magnetic lines confined within the soft magnetic backing layer more increases and a high write ability is obtained. As a result, writing of information in a medium with higher Hc is allowed. From a viewpoint of the mass productivity, however, increase in a thickness of the soft magnetic backing layer is to be avoided as much as possible. Accordingly, a method for improving the Bs of the soft magnetic backing layer is effective to obtain a high write ability.

For a material of the soft magnetic backing layer, an alloy mainly composed of Fe is used (see, e.g., Japanese Unexamined Patent Publication No. 2002-25030). Among them, a 65 at % Fe—Co alloy is known as an alloy with the highest Bs.

However, in a magnetic material of an alloy having a higher Fe composition ratio, low corrosion resistance is a problem. In order to improve corrosion resistance of such a Fe alloy, for example, a method of adding Cr is known to be generally effective from the development process of a stainless steel.

However, this method has a problem that when Cr is added to the level of securing sufficient corrosion resistance, the Bs decreases and as a result, high signal quality cannot be maintained.

### SUMMARY OF THE INVENTION

According to one aspect of the present invention, there is provided a magnetic recording medium. This magnetic recording medium includes: a non-magnetic substrate; a soft magnetic backing layer formed over the substrate, the soft magnetic backing layer being composed of a FeCoZr alloy added with at least one element of Ta and Nb and further added with Cr; an intermediate layer formed over the soft magnetic backing layer; and a recording layer formed over the intermediate layer, the recording layer exhibiting perpendicular magnetic anisotropy.

According to another aspect of the present invention, there is provided a method of manufacturing a magnetic recording medium. This method includes the steps of: forming a soft magnetic backing layer over a non-magnetic substrate, the soft magnetic backing layer being composed of a FeCoZr alloy added with at least one element of Ta and Nb and further added with Cr; forming an intermediate layer over the soft magnetic backing layer; and forming a recording layer over the intermediate layer, the recording layer having perpendicular magnetic anisotropy.

According to yet another object of the present invention, there is provided a magnetic recording device. This magnetic recording device includes: a magnetic recording medium which includes: a non-magnetic substrate; a soft magnetic backing layer formed over the substrate, the soft magnetic backing layer being composed of a FeCoZr alloy added with at least one element of Ta and Nb and further added with Cr; an intermediate layer formed over the soft magnetic backing layer; and a recording layer formed over the intermediate layer, the recording layer exhibiting perpendicular magnetic anisotropy.

### BRIEF DESCRIPTION OF THE DRAWINGS

FIG. 1 is a schematic cross-sectional view of an essential part of a magnetic recording medium and a magnetic head.

FIG. 2 is a schematic cross-sectional view of an essential part of a soft magnetic backing layer forming step.

FIG. 3 is a schematic cross-sectional view of essential parts of an orientation control layer and a non-magnetic layer forming step.

FIGS. 4A and 4B are schematic cross-sectional views of essential parts of a recording layer forming step, FIG. 4A is a schematic cross-sectional view of an essential part of the whole recording medium, and FIG. 4B is an enlarged cross-sectional view of an essential part of a main recording section.

FIG. 5 illustrates a relationship between the Cr addition amount and the Bs.

FIG. 6 illustrates a Slater-Pauling curve.

FIG. 7 illustrates corrosion resistance.

FIG. 8 is a top view of an essential part of a magnetic recording device.

### DESCRIPTION OF THE PREFERRED EMBODIMENTS

Preferred embodiments of the present invention will be described below with reference to the accompanying drawings, wherein like reference numerals refer to like elements throughout. A magnetic recording medium described in the embodiment is a perpendicular magnetic recording medium in which the direction of magnetization in a recording layer is directed to the perpendicular direction to a substrate face.

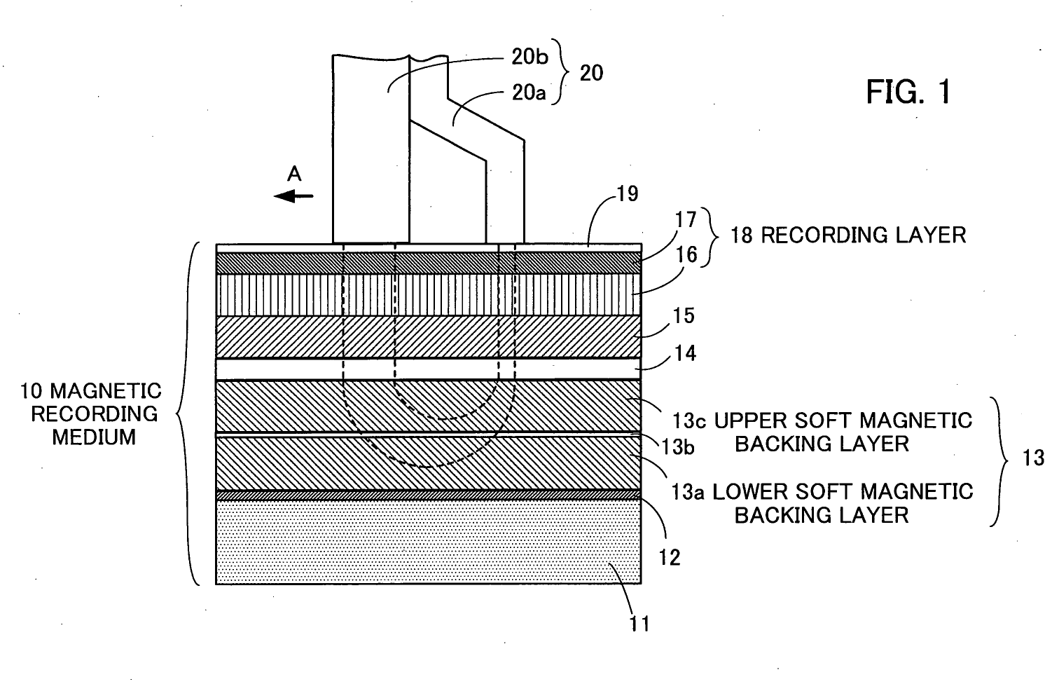

FIG. 1 is a schematic cross-sectional view of an essential part of a magnetic recording medium and a magnetic head.

A magnetic recording medium 10 includes a non-magnetic substrate 11 and a seed layer 12 formed over the substrate 11. This seed layer 12 has a function of preventing the surface state of the substrate 11 from affecting crystallinity of a film laminated over the layer 12 and also has a function as an adhesion layer.

Over the seed layer 12, a lower soft magnetic backing layer 13a is formed. The lower soft magnetic backing layer 13a is composed of a soft magnetic amorphous material, for example, an amorphous material formed of a FeCoCr alloy added with at least one or more elements selected from Zr (zirconium), Ta (tantalum), Nb (niobium), Si (silicon), B (boron), Ti (titanium), W (tungsten) and C (carbon).

Over the lower soft magnetic backing layer 13a, a magnetic domain control layer 13b is formed. Over the layer 13b, an upper soft magnetic backing layer 13c having the same material as that of the layer 13a is formed.

As described above, over the substrate 11, a backing layer 13 including the lower soft magnetic backing layer 13a, the magnetic domain control layer 13b and the upper soft magnetic backing layer 13c is formed through the seed layer 12.

Over the upper soft magnetic backing layer 13c, an orientation control layer 14 that is a first intermediate layer is formed. Over the layer 14, a non-magnetic layer 15 that is a second intermediate layer is formed.

Over the non-magnetic layer 15, a main recording layer 16 having a granular structure composed of a non-magnetic material and magnetic grains dispersed in the non-magnetic material is formed. In the main recording layer 16 of such a granular structure, the respective magnetic grains are isolated with their easy magnetization axes aligned, and therefore noise in the main recording layer 16 can be reduced.

Over the main recording layer 16, a writing assist layer 17 for assisting writing to the main recording layer 16 is formed. A layer including the main recording layer 16 and the writing assist layer 17 is referred to as a recording layer 18. Over the layer 17, a protection layer 19 is formed. By employing such a constitution, the magnetic recording medium 10 is formed.

On the other hand, the writing to the magnetic recording medium 10 by a magnetic head 20 is performed as follows. The head 20 having a main magnetic pole 20b and a return yoke 20a is opposed to the magnetic recording medium 10, and a recording magnetic field H which is generated in the main magnetic pole 20b with a small cross-sectional area and has a high magnetic flux density is induced to the recording layer 18. As a result, in magnetic domains directly under the main magnetic pole 20b in the main recording layer 16 with perpendicular magnetic anisotropy, magnetization is reversed by this recording magnetic field H, and information by magnetization is written.

After perpendicularly penetrating the main recording layer 16, the recording magnetic field H goes through the backing layer 13, which constitutes a magnetic flux circuit in corporation with the magnetic head 20, in the in-plane direction, again passes through the main recording layer 16, and then returns to the return yoke 20a with a large cross-sectional area at low magnetic flux density.

Then, the direction of the recording magnetic field H is changed according to a recording signal while the magnetic recording medium 10 and the magnetic head 20 are relatively moved in a direction of an arrow A in the drawing in a plane. Accordingly, a plurality of magnetic domains perpendicularly magnetized are continuously formed in the track direction of the recording medium 10, and the recording signal is recorded in the magnetic recording medium 10.

Next, specific constitutions of the respective layers of the magnetic recording medium will be described with a manufacturing process thereof.

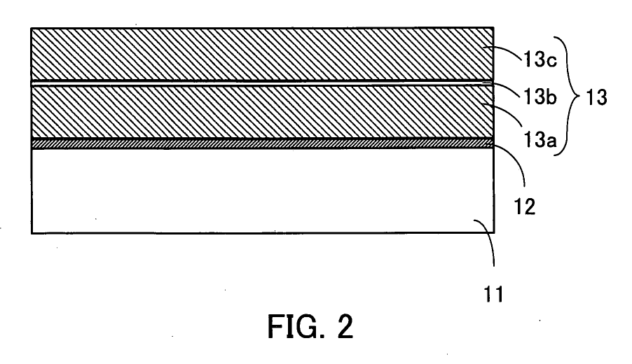

FIG. 2 is a schematic cross-sectional view of an essential part of a soft magnetic backing layer forming step.

First, over the non-magnetic substrate 11 such as a glass substrate with rigidity increased by a chemical treatment for the surface, a Cr layer is formed to a thickness of about 3 nm by a sputtering method under a film-forming pressure of about 0.3 to 0.8 Pa. The Cr layer serves as a seed layer 12.

A growth rate of the seed layer 12 is not particularly limited and is set to, for example, 5 nm/sec in the present embodiment. This seed layer 12 has a function of preventing the surface state of the substrate 11 from affecting crystallinity of a film laminated in the subsequent step and also has a function as an adhesion layer. If there is no problem in crystallinity of the film laminated over the seed layer 12, the seed layer 12 may be omitted.

The substrate 11 is not limited to the glass substrate. When the recording medium is a solid medium such as a hard disk, a resin substrate, a NiP plated aluminum alloy substrate and a silicon substrate may be used as materials of the substrate 11. When the recording medium is a flexible tape, the substrate 11 may be formed of PET (polyethylene terephthalate), PEN (polyethylene naphthalate) or polyimide.

Next, over the seed layer 12, a soft magnetic amorphous FeCoZrTaCr layer is formed to a thickness of about 30 nm by the sputtering method under the condition of film-forming pressure of 0.3 to 0.8 Pa and growth rate of 5 nm/sec. This soft magnetic amorphous FeCoZrTaCr layer serves as the lower soft magnetic backing layer 13a. However, a soft magnetic amorphous material constituting the lower soft magnetic backing layer 13a is not limited to FeCoZrTaCr. The lower soft magnetic backing layer 13a may be composed of, for example, a material formed of a FeCoCr alloy added with at least one or more elements selected from Zr, Ta, Nb, Si, B, Ti, W and C. By adding to the FeCoCr alloy at least one or more elements selected from the above-described elements, the FeCoCr alloy can be easily amorphized.

Over the lower soft magnetic backing layer 13a, an extremely thin non-magnetic layer is formed by the sputtering method. This non-magnetic layer is, for example, a Ru (ruthenium) layer with a thickness of about 0.4 to 3 nm and serves as the magnetic domain control layer 13b between the lower soft magnetic backing layer 13a and the after-mentioned upper soft magnetic backing layer 13c.

That is, the magnetic domain control layer 13b has a function of promoting a stable antiferromagnetic couple between the lower soft magnetic backing layer 13a and the after-mentioned upper soft magnetic backing layer 13c. The magnetic domain control layer 13b may be composed of Rh (rhodium), Ir (iridium) or Cu (copper) instead of Ru.

Subsequently, over the magnetic domain control layer 13b, the upper soft magnetic backing layer 13c is formed under the same film-forming conditions as those of the lower soft magnetic backing layer 13a. Specifically, an amorphous FeCoZrTaCr layer is formed over the magnetic domain control layer 13b such that the layer 13c has a thickness of about 30 nm. The upper soft magnetic backing layer 13c is composed of the same amorphous material as that of the above-described lower soft magnetic backing layer 13a.

Thus, the backing layer 13 including the lower soft magnetic backing layer 13a, the magnetic domain control layer 13b and the upper soft magnetic backing layer 13c is formed over the seed layer 12.

In the thus formed backing layer 13, the lower and upper soft magnetic backing layers 13a and 13c are antiferromagnetically coupled through the magnetic domain control layer 13b. Accordingly, the magnetizations Ml of the soft magnetic backing layers are stabilized in parallel and opposite directions.

As a result, even if there is “butting”, which is observed in the case where adjacent magnetizations are directed in opposite directions, in a film plane of the upper or lower soft magnetic backing layer 13c or 13a, magnetic flux leaking from the “butting” portion circulates within the backing layer 13 since the magnetizations of the lower and upper soft magnetic backing layers 13a and 13c are directed in parallel and opposite directions.

As a result, magnetic flux generated from magnetic walls is less likely to extend above the backing layer 13, and a later-described magnetic head does not detect the magnetic flux. This makes it possible to reduce spike noise generated at reading due to the above magnetic flux.

In another structure to reduce spike noise as described above, a soft magnetic backing layer of a single layer may be formed over an antiferromagnetic material layer. The antiferromagnetic material layer in this case is composed of, for example, IrMn or FeMn.

The soft magnetic backing layer is completed through the above-described steps.

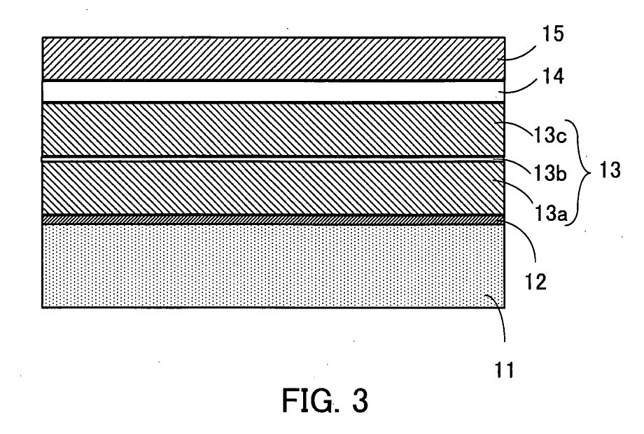

FIG. 3 is a schematic cross-sectional view of an essential part of an orientation control layer and a non-magnetic layer forming step.

Subsequently, over the upper soft magnetic backing layer 13c, a soft magnetic NiFeCr layer is formed to a thickness of about 5 nm by the sputtering method under the condition of film-forming pressure of 0.3 to 0.8 Pa and growth rate of 2 nm/sec. The NiFeCr layer serves as the orientation control layer 14.

Since FeCo alloy base amorphous materials are used for the upper soft magnetic backing layer 13c, the NiFeCr layer has a good fcc (face-centered cubic) crystal structure.

In addition to NiFeCr, this orientation control layer 14 having the fcc structure may be composed of any one of Pt, Pd (palladium), NiFe, NiFeSi, Al, Cu and In (indium), or composed of an alloy of these materials. Therefore, these materials may be used as a material of the orientation control layer 14.

When the orientation control layer 14 is composed of the soft magnetic material such as NiFe, the layer 14 can also serve as the upper soft magnetic backing layer 13c. As a result, the apparent distance between the later-described magnetic head and the upper soft magnetic backing layer 13c becomes short, and the magnetic head can sensitively detect the magnetic information.

Next, a Ru layer as the non-magnetic layer 15 is formed to a thickness of about 10 nm over the orientation control layer 14 by the sputtering method under the film-forming pressure of 4 to 10 Pa. The growth rate of the Ru layer is preferably as low as possible and is set to 0.5 nm/sec in the present embodiment.

The Ru layer constituting the non-magnetic layer 15 has an hcp (hexagonal close-packed) crystal structure. This hcp structure has a good lattice match with the fcc structure which is the crystal structure of the orientation control layer 14. More specifically, by an operation of the orientation control layer 14, the non-magnetic layer 15 with orientations aligned in one direction and with good crystallinity is grown over the orientation control layer 14.

The non-magnetic layer 15 with the hcp structure may be composed of, instead of the Ru layer, an Ru alloy including Ru and any one of Co, Cr, W, and Re (rhenium).

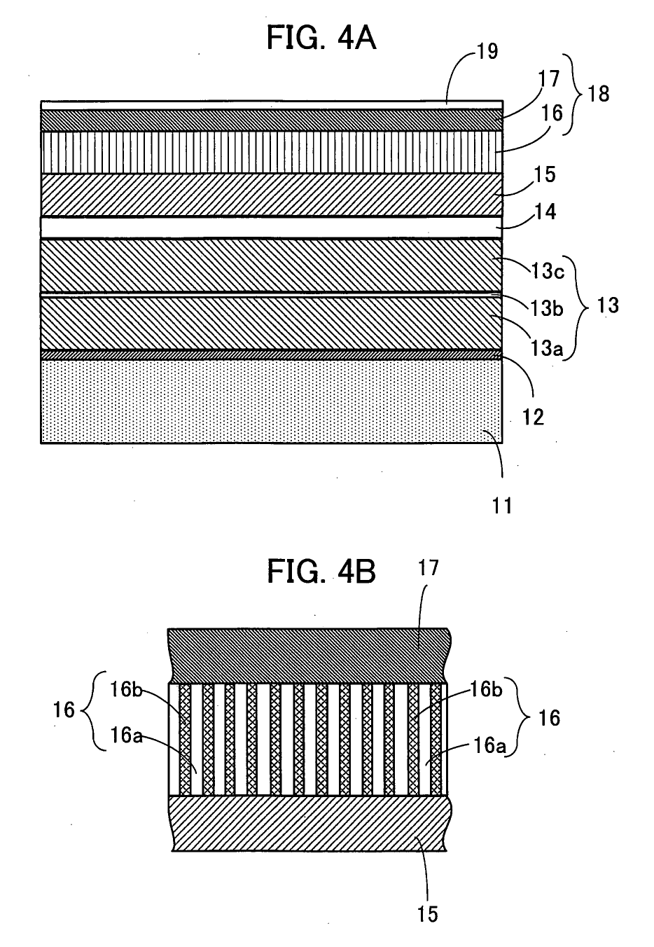

FIGS. 4A and 4B are schematic cross-sectional views of essential parts of a recording layer forming step, FIG. 4A is a schematic cross-sectional view of an essential part of the whole recording medium, and FIG. 4B is an enlarged cross-sectional view of an essential part of the main recording section.

Next, the substrate 11 including from the seed layer 12 to the non-magnetic layer 15 is put in a sputtering chamber. A Co₆₆Cr₁₄Pt₂₀ target and a SiO₂ (oxide silicon) target are provided in the sputtering chamber. In the present embodiment, the alloy described as Co₆₆Cr₁₄Pt₂₀ is defined as a CoCrPt alloy having Co content of 66 at %, Cr content of 14 at % and Pt content of 20 at %.

Next, mixed gas including Ar (argon) gas added with a small amount of O₂ (oxygen), for example, O₂ of 0.2% to 2% at flow rate is introduced into the chamber as sputtering gas. The pressure is stabilized at a relatively high pressure of about 3 to 7 Pa, and the substrate temperature is maintained at a relatively low temperature of 10 to 80° C.

In this state, sputtering of Co₆₆Cr₁₄Pt₂₀ and SiO₂ is performed by applying a high-frequency power of 400 to 1000 W between the targets and the substrate 11. A frequency of the high-frequency power is not particularly limited and for example, may be 13.56 MHz. Alternatively, a DC power of about 400 to 1000 W may be used to perform the sputtering.

As described above, when film-forming conditions of a relatively high pressure (about 3 to 7 Pa) and a low temperature (about 10 to 80° C.) are employed in the sputtering method, a film with lower density is formed as compared with the case of film formation at low pressure and high temperature. Therefore, the target materials Co₆₆Cr₁₄Pt₂₀ and SiO₂ are not mixed with each other and, the main recording layer 16 with a granular structure in which magnetic grains 16b composed of the Co₆₆Cr₁₄Pt₂₀ are dispersed in a non-magnetic material 16a composed of the SiO₂ is formed over the non-magnetic layer 15.

In the main recording layer 16, the content rate of the non-magnetic material 16a is not particularly limited, but is preferably about 5 to 15 at %. In this embodiment, a (Co₆₆Cr₁₄Pt₂₀)93(SiO₂)7 layer containing 7 at % of the non-magnetic material 16a as an example is formed as the main recording layer 16.

The thickness of the main recording layer 16 is not particularly limited and is, for example, 12 nm in this embodiment. The growth rate of the main recording layer 16 is, for example, 5 nm/sec.

The non-magnetic layer 15 of the hcp structure under the main recording layer 16 functions to align orientations of the magnetic grains 16b in the perpendicular direction to a film surface. The magnetic grains 16b therefore have an hcp crystal structure extending in the perpendicular direction similar to the non-magnetic layer 15. Moreover, the height direction of a hexagonal column of the hcp structure becomes an easy magnetization axis of the main recording layer 16, and therefore the main recording layer 16 exhibits perpendicular magnetic anisotropy.

In the main recording layer 16 of such a granular structure, the respective magnetic grains 16b are isolated with their easy magnetization axes aligned, and therefore noise in the main recording layer 16 can be reduced.

In the magnetic grains 16b, when a Pt content rate is set to 25 at % or more, the magnetic anisotropy constant Kᵤ of the main recording layer 16 is lowered. Preferably, the Pt content rate of the magnetic grains 16b is therefore less than 25 at %.

Furthermore, by adding a small amount of O₂ of about 0.2 to 2% at the flow rate to the sputtering gas as described above, isolation of the magnetic grains 16b in the main recording layer 16 is promoted and as a result, an electromagnetic conversion characteristic can be improved.

Incidentally, the isolation of the magnetic grains 16b, in other words, an increase in distance between each adjacent pair of the magnetic grains 16b, can be promoted by increasing the unevenness of the surface of the non-magnetic layer 15 under the main recording layer 16. To increase the unevenness, the Ru layer constituting the non-magnetic layer 15 may be grown at a low growth rate of about 0.5 nm/sec as described above.

The non-magnetic material 16a is SiO₂ in the above description. Further, the material 16a may be also an oxide other than SiO₂. Such an oxide is, for example, an oxide of Ti, Cr or Zr. Moreover, the non-magnetic material 16a may be a nitride of Si, Ti, Cr, or Zr.

Furthermore, the magnetic grains 16b may be grains composed of a CoFe alloy containing Co and Fe. In the case of using the CoFe alloy, the main recording layer 16 is preferably heat-treated to form an HCT (Honeycomb Chained Triangle) structure as the crystal structure of the magnetic grains 16b. Moreover, Cu or Ag (silver) may be added to the CoFe alloy.

Next, an alloy layer containing Co and Cr, for example, a Co₆₇Cr₁₉Pt₁₀B₄ layer is formed to a thickness of about 6 nm over the main recording layer 16 by the sputtering method using Ar gas as sputtering gas. The Co₆₇Cr₁₉Pt₁₀B₄ layer serves as a writing assist layer 17 which assists writing to the main recording layer 16. The film-forming conditions of the writing assist layer 17 are not particularly limited but are, for example, a film-forming pressure of 0.3 to 0.8 Pa and a growth rate of 5 nm/sec in this embodiment.

The Co₆₇Cr₁₉Pt₁₀B₄ layer constituting the writing assist layer 17 has the same hcp crystal structure as the magnetic grains 16b in the main recording layer 16 thereunder. Therefore, the writing assist layer 17 and the magnetic grains 6b have a good lattice match, and the writing assist layer 17 with good crystallinity is grown over the main recording layer 16. The writing assist layer 17 is not limited to a single layer and may be, for example, a layer formed by laminating at least one layer or more layers of a Co-based alloy thin film.

Subsequently, a DLC (Diamond Like Carbon) layer as the protection layer 19 is formed to a thickness of about 4 nm over the recording layer 18 by means of RF-CVD (Radio Frequency-Chemical Vapor Deposition) method using C 2H 2 (acetylene) gas as reactive gas.

The film-forming conditions of the protection layer 19 are, for example, a film-forming pressure of about 4 Pa, a high frequency power of 1000 W, and a bias voltage between the substrate and a shower head of 200 V.

Thus, a basic structure of the magnetic recording medium 10 according to this embodiment is completed.

Next, the Bs of an alloy material obtained by adding Cr to a Fe₆₁CO₃₃Zr₄Ta₂ alloy, a Fe₆₁Co₃₃Zr₄Nb₂ alloy and a Fe₅₇Co₃₁B₁₂ alloy will be described.

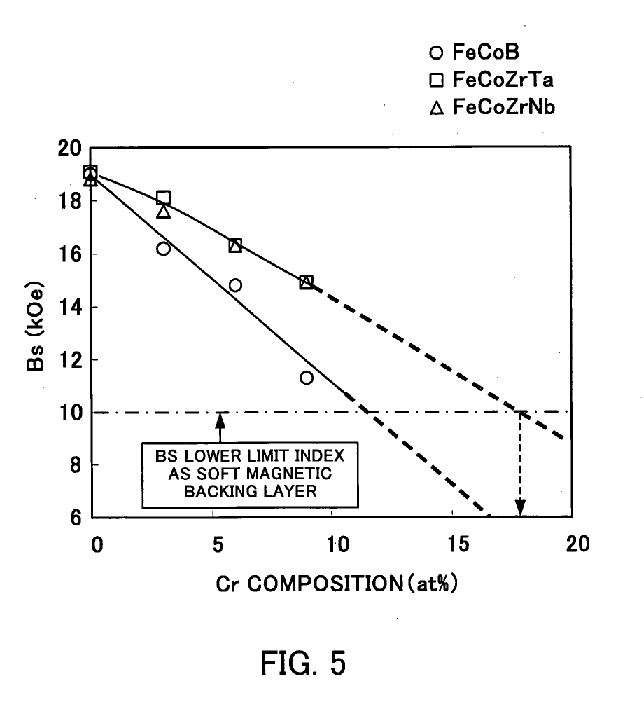

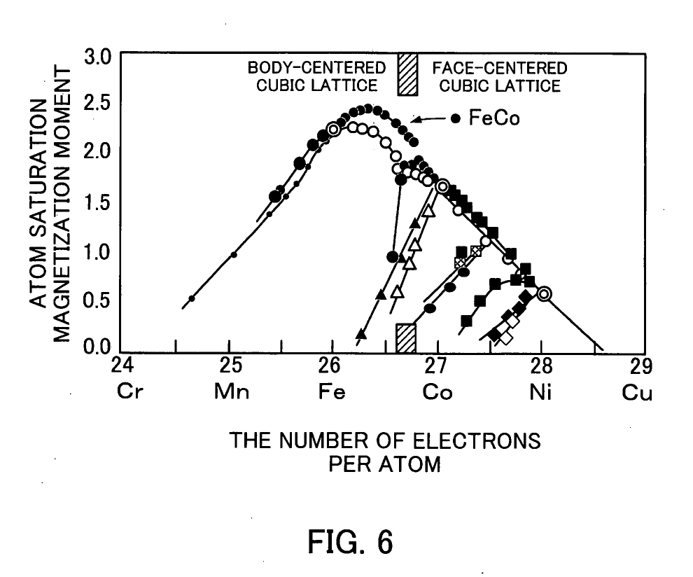

FIG. 5 illustrates a relationship between the Cr addition amount and the Bs. In this figure, the horizontal axis represents the Cr addition amount, namely, the Cr composition (at %), and the vertical axis represents the Bs (kOe). FIG. 6 illustrates a Slater-Pauling curve. In this figure, the horizontal axis represents the number of electrons per atom, and the vertical axis represents the atom saturation magnetization moment.

Three types of alloys shown in FIG. 5 before adding Cr are amorphous alloys obtained by adding any of Zr, Ta, Nb and B to an alloy having a ratio of Fe:Co=65:35. All of three types of the alloys show a Bs value as high as about 19 kOe.

Here, the reason why a ratio of Fe to Co is set to 65:35 is that, as is apparent from the Slater-Pauling curve shown in FIG. 6, an alloy with this ratio shows the highest Bs.

The FeCoB alloy is a material generally used as a high Bs soft magnetic material of the perpendicular magnetic recording medium and is here shown in FIG. 5 as a reference.

From the result of FIG. 5, the following facts are found. When the Cr addition amount increases, the Bs values of all alloys decrease. Note, however, that in the FeCoZrTa alloy and the FeCoZrNb alloy, the lowering of the Bs to the Cr addition amount slows down as compared with the FeCoB alloy and the Bs value is relatively higher than that of the FeCoB alloy.

As described above, a material with a higher Bs value is preferably used for the soft magnetic backing layer. However, a material with a relatively lower Bs value (e.g., a material containing no Fe, or a material containing a small amount of Fe when containing Fe) is frequently used to elevate corrosion resistance.

Even in the case of using a material with a lower Bs value, when a thickness of the soft magnetic backing layer is increased, write ability increases.

However, in order to elevate mass productivity of the perpendicular magnetic recording medium, it is important to form the soft magnetic backing layer to a thickness of 100 nm or less. In order to further elevate mass productivity of the perpendicular magnetic recording medium, it is preferable to form the soft magnetic backing layer to a thickness of 50 nm or less.

In order to obtain sufficient write ability even in such a thickness, the material must have the Bs of 10 kOe or more. Accordingly, an upper limit of the amount of Cr added to the FeCoZrTa alloy and the FeCoZrNb alloy is 18 at % from the result of FIG. 5.

Next, the corrosion resistance of the FeCoZrTa alloy and FeCoZrNb alloy added with Cr is studied. The JIS salt spray test is applied to evaluation of the corrosion resistance.

A specific method of the salt spray test is as follows. First, a weight of a test object (alloy ribbon) is measured. Next, the alloy ribbon is placed in a thermostatic chamber at 35° C., continuously sprayed with a 5% NaCl solution for 16 hours and then dried. Then, a weight of the alloy ribbon is again measured. In the case where the Fe corrosion proceeds, the weight increases due to formation of oxides and hydroxides. Therefore, it is considered that as the weight increasing rate is larger, the corrosion resistance is lower.

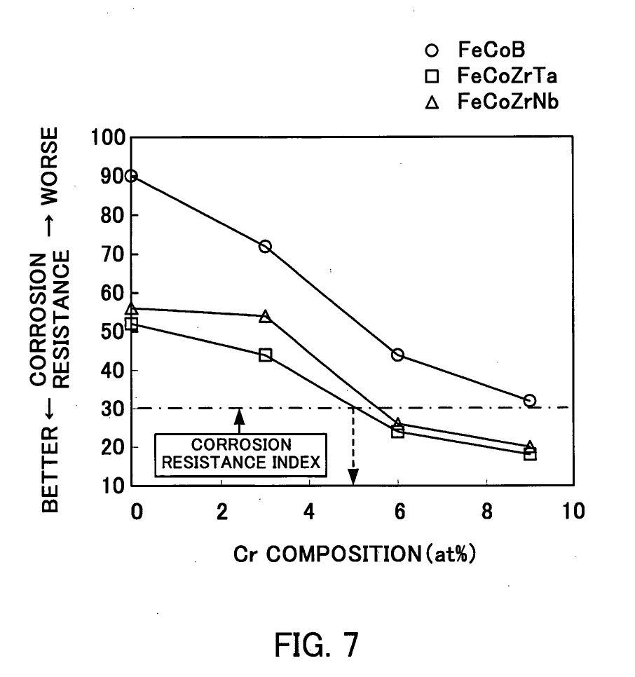

FIG. 7 illustrates the corrosion resistance. In the figure, the horizontal axis represents the Cr addition amount, namely, the Cr composition (at %). The vertical axis represents the corrosion resistance represented by a given value. As the given value is lower, the corrosion resistance is higher.

By comparison of the alloys before the addition of Cr, that is, the alloys to which the Cr addition amount is 0 at %, the following facts are found. As shown in FIG. 7, the FeCoZrTa alloy and the FeCoZrNb alloy has higher corrosion resistance than the FeCoB alloy. Further, even if Cr is added to these alloys, the corrosion resistance of the FeCoZrTa alloy and the FeCoZrNb alloy is relatively higher than that of the FeCoB alloy.

The electrochemical method (method for evaluating a current in dropping an acid on the magnetic recording medium and in applying a voltage on the medium) is applied to the corrosion resistance evaluation in the magnetic recording medium. From the corrosion resistance criteria in such a method, it is experimentally known that if the corrosion resistance of an alloy is 30 or less (arbitrary unit) in the salt spray test, this value is at a problem-free level for use in the magnetic recording medium.

From the above test results, it is found that if 5 at % or more of Cr is added to the FeCoZrTa alloy and the FeCoZrNb alloy, sufficient corrosion resistance can be secured.

Accordingly, it is found that when 5 to 18 at % of Cr is incorporated into the FeCoZrTa alloy and FeCoZrNb alloy as the soft magnetic backing layer, there can be realized the magnetic recording medium which strikes a balance between high corrosion resistance and high data quality.

Next, a magnetic recording device 30 including the magnetic recording medium 10 and magnetic head 20 shown in FIG. 1 will be described.

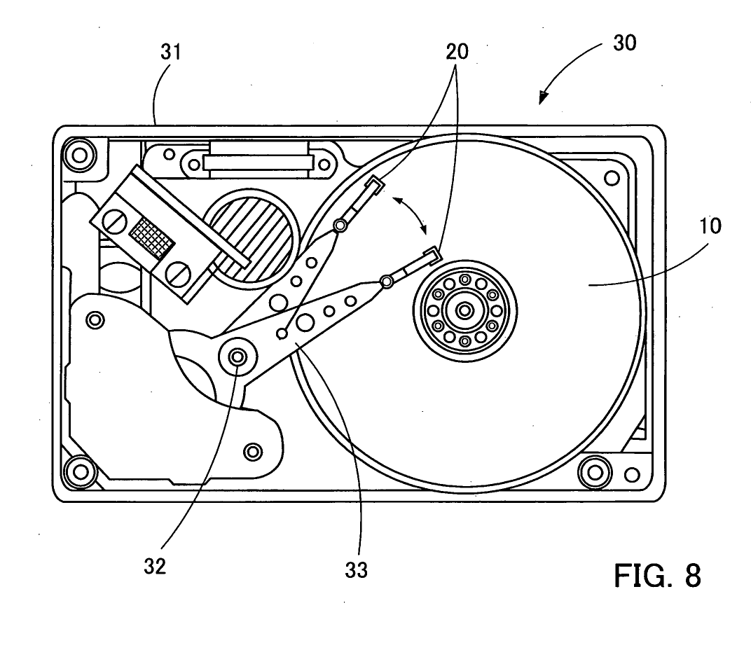

FIG. 8 is a top view of an essential part of the magnetic recording device. This magnetic recording device 30 is used as, for example, a hard disk device mounted on a personal computer or a television recorder.

In this magnetic recording device 30, the magnetic recording medium 10 is housed in a case 31 as a hard disk so as to be rotated by a spindle motor.

A carriage arm 33 which can be rotated around a shaft 32 by an actuator is provided within the case 31. The magnetic head 20 provided at an end of the carriage arm 33 scans the magnetic recording medium 10 from above to perform writing and reading of magnetic information to and from the magnetic recording medium 10.

The type of the magnetic head 20 is not particularly limited, and the magnetic head 20 may be composed of a GMR (Giant Magnetro Resistive) element or a TMR (Ferromagnetic Tunnel Junction Magnetro Resistive) element.

The thus-structured magnetic recording device 30 comprises the magnetic recording medium 10 with excellent corrosion resistance and high Bs and therefore, exhibits high corrosion resistance and high Hc recording as well as high S/N performance. When such a magnetic recording device 30 is used, the reliability for storing information is assured over a long period of time.

The magnetic recording device 30 is not limited to the above hard disk device and may be a device for recording magnetic information in a flexible tape-like magnetic recording medium.

In the present invention, the magnetic recording medium comprises: a non-magnetic substrate; a soft magnetic backing layer formed over the substrate, the soft magnetic backing layer being composed of a FeCoZr alloy added with at least one element of Ta and Nb and further added with Cr; an intermediate layer formed over the soft magnetic backing layer; and a recording layer formed over the intermediate layer, the recording layer exhibiting perpendicular magnetic anisotropy.

Further, in the present invention, the method of manufacturing a magnetic recording medium comprises the steps of: forming a soft magnetic backing layer over a non-magnetic substrate, the soft magnetic backing layer being composed of a FeCoZr alloy added with at least one element of Ta and Nb and further added with Cr; forming an intermediate layer over the soft magnetic backing layer; and forming a recording layer over the intermediate layer, the recording layer having perpendicular magnetic anisotropy.

Further, in the present invention, the magnetic recording device comprises: a magnetic recording medium which includes: a non-magnetic substrate; a soft magnetic backing layer formed over the substrate, the soft magnetic backing layer being composed of a FeCoZr alloy added with at least one element of Ta and Nb and further added with Cr; an intermediate layer formed over the soft magnetic backing layer; and a recording layer formed over the intermediate layer, the recording layer exhibiting perpendicular magnetic anisotropy.

Therefore, it is possible to realize the magnetic recording medium including the soft magnetic backing layer with high corrosion resistance and high Bs and therefore exhibiting high corrosion resistance, high Hc recording as well as high S/N performance. Further, it is possible to realize the method of manufacturing the magnetic recording medium and to realize the magnetic recording device.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A magnetic recording medium, comprising:
a non-magnetic substrate;
a soft magnetic backing layer formed over the substrate, the soft magnetic backing layer being composed of a FeCoZr alloy added with at least one element of Ta and Nb and further added with Cr;
an intermediate layer formed over the soft magnetic backing layer; and
a recording layer formed over the intermediate layer, the recording layer exhibiting perpendicular magnetic anisotropy.

2. The magnetic recording medium according to claim 1, wherein the FeCoZr alloy is added with at least one element of Zr, Ta, Nb, Si, B, Ti, W, Cr and C.

3. The magnetic recording medium according to claim 1, wherein an element ratio of Fe to Co is 65:35 in the soft magnetic backing layer.

4. The magnetic recording medium according to claim 1, wherein a Cr content is 5 to 18 at % in the soft magnetic backing layer.

5. The magnetic recording medium according to claim 1, wherein the intermediate layer formed between the recording layer and the soft magnetic backing layer is a coating layer formed by laminating a second polycrystalline thin film having an hcp structure over a first polycrystalline thin film having an fcc structure.

6. The magnetic recording medium according to claim 1, wherein the intermediate layer includes an orientation control layer for controlling crystallinity of the recording layer.

7. The magnetic recording medium according to claim 1, wherein the recording layer has a granular structure composed of a non-magnetic material and magnetic grains dispersed in the non-magnetic material.

8. The magnetic recording medium according to claim 1, wherein at least one or more layers of a Co-based alloy thin film is laminated over the recording layer.

9. A method of manufacturing a magnetic recording medium, comprising the steps of:
forming a soft magnetic backing layer over a non-magnetic substrate, the soft magnetic backing layer being composed of a FeCoZr alloy added with at least one element of Ta and Nb and further added with Cr;
forming an intermediate layer over the soft magnetic backing layer; and
forming a recording layer over the intermediate layer, the recording layer having perpendicular magnetic anisotropy.

10. The method according to claim 9, wherein the intermediate layer is a coating layer formed by laminating a second polycrystalline thin film having an hcp structure over a first polycrystalline thin film having an fcc structure.

11. A magnetic recording device, comprising:
a magnetic recording medium which includes:
a non-magnetic substrate;
a soft magnetic backing layer formed over the substrate, the soft magnetic backing layer being composed of a FeCoZr alloy added with at least one element of Ta and Nb and further added with Cr;
an intermediate layer formed over the soft magnetic backing layer; and
a recording layer formed over the intermediate layer, the recording layer exhibiting perpendicular magnetic anisotropy.
